(19) United States
(12) Patent Application Publication
(10) Pub. No.: US 2011/0093352 A1
(43) Pub. Date: Apr. 21, 2011

(54) Information Sharing System for Comparing Global Prices

(76) Inventors: Philip Sarmiento, Hayward, CA (US); Edgar Sarmiento, Falls Church, VA (US)

(21) Appl. No.: 12/901,551

(22) Filed: Oct. 10, 2010

Related U.S. Application Data
(60) Provisional application No. 61/252,144, filed on Oct. 15, 2009.

(51) Int. Cl. G06Q 30/00

(52) U.S. Cl. 705/26.1

(57) ABSTRACT

An information sharing method and system to facilitate global price comparison is shown. Information on goods and services and prices are collected from consumers in different geographical locations. Each good or service can have multiple prices. The data is aggregated and searchable, and the data can be retrieved, normalized, and organized to present a comparison to users. The method includes a global benchmark price and options to ask and answer location-specific price questions. The present invention has applications on the World Wide Web.

### CROSS-REFERENCE TO RELATED APPLICATIONS

This application claims the benefit of provisional application No. 61/252,144 filed Oct. 15, 2009.

### STATEMENT REGARDING FEDERALLY SPONSORED RESEARCH

Not applicable.

### BACKGROUND OF THE INVENTION

With increasing globalization, the need to compare global prices is rising. However, global price comparison is difficult. Most notably, prices are hard to obtain and can vary over time. Most price comparison services use only the current listed prices posted by merchants. Merchants utilize many different methods and media to sell their goods and services. Many consumers pay less than the listed prices due to discounts or special offers. Conversely, consumers can pay more than the listed price if demand is high. A more accurate global price comparison is from consumers based on the amount paid or to be paid for the good or service.

Prices can also take many forms, including different currencies, unit of measure, and quality characteristics. In global comparison shopping, for instance, it is often necessary to determine a unit of measure and calculate the price of goods in pounds or kilograms in order to determine which offers the better cost per unit. Foreign currency conversion and sales taxes also make difficult price comparison around the world.

### BRIEF DESCRIPTION OF THE INVENTION

The present invention is a method and system to facilitate global price comparison. To solve the problem of obtaining real prices, we reach out directly to consumers. This is in contrast to existing price comparison methods, which provide information based on merchant information. In this method, consumers provide the information on goods and services and prices via a browser on a computer or mobile telecommunications device. The good or service attributes include name, picture, and category. The price attributes include amount—the purchased or available for purchase price—geographical location, currency, unit of measure type/value, before/after tax identification, date, and retailer.

In this method, collection of price attributes is not limited to the consumer who provided the good or service attributes. Multiple consumers can add multiple price attributes to a good or service.

To solve the problem of accurate price comparison, the present invention includes a process to determine unit of measure type. If the price attribute is the initial price attribute, then the present invention will take the initial unit of measure type and assign the same type for all subsequent price attributes. This will help in normalizing data for comparing global prices.

The collected information is stored into a database, which a user can search. Upon finding a good or service, the corresponding data on price attributes are retrieved, normalized, and presented to the user for comparison. The presentation includes a benchmark global average price and the individual price attributes.

In addition, the user can ask other users to provide prices on a good or service in a geographical location, if none currently exist.

In addition, the user can answer other users' geographical location-specific price questions for a good or service.

The primary users of the present invention are expected to be price conscious shoppers (these individuals are frequently concerned about finding a good deal), vendors and manufacturers (these companies are frequently concerned about pricing strategies), market watchers (these individuals are concerned about macroeconomic and inflation trends), job seekers, who may relocate outside their home location (these individuals are concerned about cost of living issues), and international travelers (these individuals are concerned about trip preparation).

### BRIEF DESCRIPTION OF THE DRAWINGS

For the present invention to be easily understood and readily practiced, the present invention will now be described, for purposes of illustration and not limitation, in conjunction with the following figures, wherein:

FIG. 1 is a block flow diagram of the information sharing process to compare global prices.

FIG. 2 is a block flow diagram for a sub-process (executed in FIG. 1) to collect price attribute information, including unit of measure type.

### DETAILED DESCRIPTION OF THE INVENTION

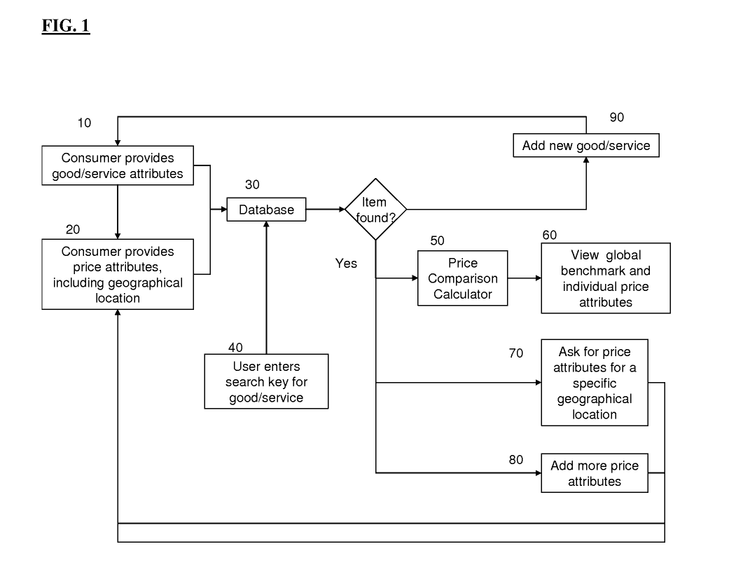

The present invention is designed to facilitate finding, sharing, and comparing global prices. In FIG. 1 at 10, information is collected from consumers on goods and services via browsers on computers or mobile telecommunication devices. In the interface, consumers provide a good or service name, picture, and category. The name and picture identify the good or service. In general, the name includes the brand and a reference to quantity, such as large or small.

Some good examples of names are “Starbucks Cappuccino (large cup)”, “Louis Vuitton Monogram Speedy handbag (one)”, or “Daily local newspaper (one at newsstand price)”. Some bad examples of names are “Winter Jacket”, which is too vague, or “Northface Winter Jacket Aloe II, Blue & Grey, from Macys”, which is too restrictive. Instructions are built into the present invention to encourage collection of clear good and service names.

Use of categories allow grouping of similar goods and services. In the present invention, categories cover a cross section of goods and services. They are Food & Drink, Clothing & Accessories, Home, Electronics, Personal Life, Health Beauty & Fitness, Transportation, and Professional Services. The good or service name, picture, and category are stored onto a database in FIG. 1. at 30.

In FIG. 1 at 20, information is collected from consumers on price attributes of a good or service via browsers on computers or mobile telecommunication devices. In the interface, the price attributes collected from consumers include: Geographical location (such as country, state/province/region, and city), Currency, Amount (purchased or available for purchase price less any discounts, rebates, or credits), Before Tax/After Tax identification, Date of price, and Retailer name.

In the present embodiment of the invention, goods and services are considered new, so the need to track quality attributes are minimized.

Price attributes also include Unit of Measure type and value. Most of the time, the Unit of Measure type is “unit” and value is “per unit”. The other Unit of Measure types and values, respectively, include weight (lbs, kg), volume (gallon, liter), length (ft, m), and area (sq.ft, sq.m).

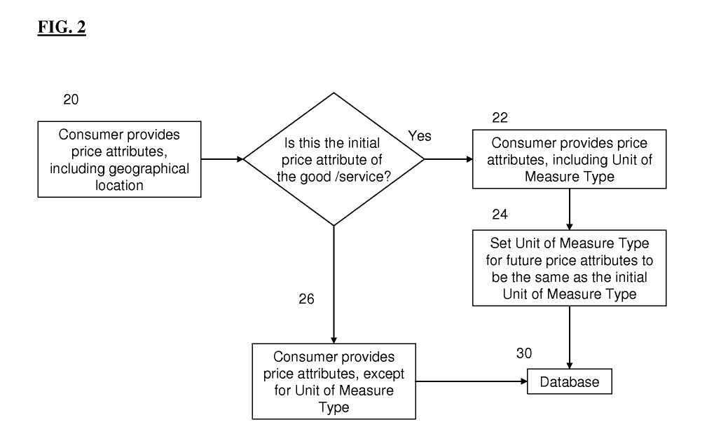

Moreover, in FIG. 2, if the price attribute is the initial price attribute of the good or service, then the present invention will fix the unit of measure type and allow only that unit of measure type for all subsequent price attributes. This will help standardize prices for global price comparison.

Collection of price attributes is not limited to one consumer. Multiple consumers can provide multiple price attributes on a good or service. The price attributes information is stored onto a database in FIG. 1 at 30.

In FIG. 1 at 40, the user enters in a search key to find a good or service. The user is presented with a list of goods and services and selects one good or service. Data is retrieved related to the price attributes. For each good or service, the following summary information is provided in FIG. 1 at 60—Global benchmark average price, Maximum reported price, Minimum reported price, # of Prices, and # of Countries with prices. Global benchmark price is a general indicator of the cost. It is the average of all data points. Standard comparison calculations are applied, including foreign exchange rates and sales tax, to make the prices globally comparable in FIG. 1 at 50. The individual price attributes are also presented to the user in FIG. 1 at 60.

If no price attributes exist for a desired geographical location, the user has an option to ask other users to provide price attributes. To ask a price question, the user identifies a good or service and desired geographical location. In the present invention, FIG. 1 at 70, the user finds the good or service, clicks an “ask price” button, and provides a location.

Price questions are listed in a separate area labeled “pending prices”. To answer a price question, the user clicks on a link labeled for the good or service “pending prices” and provides the prices in the asked for location.

Moreover, the user has an option to add more price attributes on the good or service. The more price attributes, the more accurate the global average benchmark price. Adding more prices begins in FIG. 1 at 70, and transitions to the initial process for collecting information on price attributes in FIG. 1 at 20.

Moreover, if the user did not find the desired good or service after entering in the search key in FIG. 1 at 40, the user can add a good or service. Adding a new good or service begins in FIG. 1 at 90, and transitions to the initial process for collecting information on good or services attributes in FIG. 1 at 10.

While the present invention has been described in connection with preferred embodiments thereof, those of ordinary skill in the art will recognize that many modifications and variations are possible. The present invention is intended to be limited only by the following claim and not by the foregoing description which is intended to set forth the presently preferred embodiment.

What is claimed is:

1. A method to facilitate global price comparison, where information on goods and services and prices are collected from consumers in different geographical locations via a browser on a computer or mobile telecommunications device, aggregated, normalized, and presented for comparison to users, and includes the ability for users to ask and answer location-specific price questions, said method comprising:
collecting information from consumers on a good or service name, picture, and category;
storing said data into a database;
collecting information from consumers on price attributes of the good or service consisting of amount, geographical location, currency, unit of measure type and value, before/after tax identification, calendar date, and retailer name;
determining if the price attribute is the initial price attribute, and if the price attribute is not the initial price attribute, limiting the user to the initial unit of measure type, as this will ensure data integrity for accurate comparison;
storing said data into a database;
entering by a user a search key to find a good or service;
presenting to the user a list of goods and services associated with the search key;
choosing by the user a good or service and retrieving the associated data on price attributes;
presenting to the user information for global price comparison, including the benchmark global average price and conversion of individual price attributes based on foreign exchange rates, sales tax rates, and unit of measures;
furnishing an option to the user to add more price attributes on the good or service;
furnishing an option to the user to add a good or service, if the initial search query did not return the desired good or service;
furnishing an option to the user to ask other users to provide price attributes on the good or service at a location, if none exists for the location;
furnishing an option to the user to answer location-specific price questions on the good or service.
